(19) United States
(12) Patent Application Publication
(10) Pub. No.: US 2025/0348945 A1
(43) Pub. Date: Nov. 13, 2025

(54) Insurance Management Method and System for Value-Fluctuated Mobility Device

(71) Applicants: Hyundai Motor Company, Seoul (KR); Kia Corporation, Seoul (KR)

(72) Inventor: Kimyoung Hong, Hwaseong-si (KR)

(21) Appl. No.: 18/934,891

(22) Filed: Nov. 1, 2024

(30) Foreign Application Priority Data
May 7, 2024 (KR) 10-2024-0060031

(51) Int. Cl. G06Q 40/08; G06Q 10/20

(52) U.S. Cl. CPC G06Q 40/08; G06Q 10/20

(57) ABSTRACT

A server of an assessment management system for a value-fluctuating mobility device. A first server (e.g., a main server) may include: a memory configured to store at least one instruction; and one or more processors configured to execute the at least one instruction stored in the memory to: send, to a second server, attribute information of the mobility device indicating that a service of at least one device part of the mobility device is associated with at least one of an accident risk value or a user convenience value of the mobility device, receive, from the second server, a first assessment estimate that is determined based on the accident risk value, receive, from a user device, an indication of approval of the first assessment estimate, and send, to the second server, information about the first indication.

### CROSS REFERENCE TO RELATED APPLICATION

The present application claims priority to Korean Patent Application No. 10-2024-0060031, filed May 7, 2024, the entire contents of which are incorporated herein for all purposes by this reference.

### TECHNICAL FIELD

The present disclosure relates to a management system and method for a value-fluctuating mobility device, and more particularly, to a management system and method for a mobility device whose value fluctuates according to modifications to a service for the mobility device.

### BACKGROUND

Software-Defined Vehicles (SDVs) may be a mobility device that is capable of performing over-the-air (OTA) updates of its functions after the purchase of the mobility device. The SDVs may be capable of allowing customers to select and purchase desired services (e.g., subscription services), such as features-on-demand (FOD), in the form of software updates.

Accordingly, the functionality of the mobility device may change after the time of purchase due to additions, changes, and terminations of various services. As a result, the overall value of the mobility device may fluctuate over time.

### SUMMARY

An object of the present disclosure is to provide a management system and method for a value-fluctuated mobility device that manages assessment of a mobility device whose value fluctuates according to addition, change, termination, etc. of a subscription service for the mobility device.

The technical problems solved by the present disclosure are not limited to the above technical problems and other technical problems which are not described herein will be clearly understood by a person (hereinafter referred to as an ordinary technician) having ordinary skill in the technical field, to which the present disclosure belongs, from the following description.

According to one or more example embodiments of the present disclosure, a first server may include: memory configured to store at least one instruction; and one or more processors configured to execute the at least one instruction stored in the memory to: send, to a second server, attribute information of a mobility device. The attribute information may indicate that a service of at least one device part of the mobility device is associated with at least one of an accident risk value or a user convenience value of the mobility device. The one or more processors may be further configured to: receive, from the second server, a first assessment estimate that is determined based on at least one of the accident risk value or the user convenience value; receive, from a user device, an indication of approval of the first assessment estimate; and send, to the second server, information about the indication of approval of the first assessment estimate.

The one or more processors may be further configured to: receive, from the user device, a request for a second service of at least one second device part of the mobility device. The second service may be associated with at least one of a second accident risk value or a second user convenience value of the mobility device. The one or more processors may be further configured to receive, based on the request, a second assessment estimate that is determined based on at least one of the second accident risk value or the second user convenience value.

The one or more processors may be further configured to: send, to the user device, the second assessment estimate; receive, from the user device, an indication of approval of the second assessment estimate; and send, to the second server, information about the indication of approval of the second assessment estimate.

The second server may include a plurality of second servers. The one or more processors may be further configured to receive, from the plurality of second servers, a plurality of assessment estimates. The second assessment estimate may be different from at least one of the plurality of assessment estimates.

The one or more processors may be further configured to: receive, from the user device, an indication of termination of the service for the mobility device; and receive, from the second server, a second assessment estimate that reflects the termination of the service.

The one or more processors may be further configured to: send, to the user device, the second assessment estimate; receive, from the user device, an indication of approval of the second assessment estimate; and send, to the second server, information about the indication of approval of the second assessment estimate.

The second server may include a plurality of second servers. The one or more processors may be further configured to receive, from the plurality of second servers, a plurality of assessment estimates. The second assessment estimate that reflects the termination of the service may be different from at least one of the plurality of assessment estimates.

According to one or more example embodiments of the present disclosure, a second server may include: a transceiver configured to transmit and receive one or more signals; and one or more processors configured to control the transceiver. The one or more processors may be configured to: receive, from a user device, a request for an assessment estimate; receive, from a first server, attribute information of a mobility device. The attribute information may indicate that a service of at least one device part of the mobility device is associated with at least one of an accident risk value or a user convenience value of the mobility device. The one or more processors may be further configured to determine, based on at least one of the accident risk value or the user convenience value, a first assessment estimate; send, to the user device, the first assessment estimate; receive, from the user device, an indication of approval of the first assessment estimate; and send, to the first server, information about the indication of approval of the first assessment estimate.

The one or more processors may be further configured to: receive, from the first server, an indication of a second service of at least one second device part of the mobility device. The second service may be associated with at least one of a second accident risk value or a second user convenience value of the mobility device. The one or more processors may be further configured to send, to the user device, a second assessment estimate that is determined based on at least one of the second accident risk value or the second user convenience value.

The one or more processors may be configured to: receive, from the user device, an indication of approval of the second assessment estimate; and send, to the first server, information about the indication of approval of the second assessment estimate.

The second server may further include a plurality of second servers. The one or more processors may be configured to determine, for each of the plurality of second servers, a different one of a plurality of assessment estimates. The second assessment estimate may be different from at least one of the plurality of assessment estimates.

The one or more processors may be further configured to: receive, from the first server, an indication of termination of the service; and send, to the user device, a second assessment estimate that reflects the termination of the service.

The one or more processors may be configured to: receive, from the user device, an indication of approval of the second assessment estimate.

The second server may include a plurality of second servers. The one or more processors may be configured to determine, for each of the plurality of second servers, a different one of a plurality of assessment estimates. The second assessment estimate that reflects the termination of the service may be different from at least one of the plurality of assessment estimates.

According to one or more example embodiments of the present disclosure, a method may include: sending, by a first server to a second server, attribute information of a mobility device. The attribute information may indicate that a service of at least one device part of the mobility device is associated with at least one of an accident risk value or a user convenience value of the mobility device. The method may further include; receiving, from the second server, a first assessment estimate that is determined based on at least one of the accident risk value or the user convenience value; receiving, from a user device, an indication of approval of the first assessment estimate; and sending, to the second server, information about the indication of approval of the first assessment estimate.

The method may further include: receiving, from the user device, a request for a second service of at least one second device part of the mobility device. The second service may be associated with at least one of a second accident risk value or a second user convenience value of the mobility device. The method may further include: receiving, based on the request, a second assessment estimate that is determined based on at least one of the second accident risk value or the second user convenience value.

The method may further include: sending, to the user device, the second assessment estimate; receiving, from the user device, an indication of approval of the second assessment estimate; and sending, to the second server, information about the indication of approval of the second assessment estimate.

The second server may include a plurality of second servers. The method may further include: receiving, from the plurality of second servers, a plurality of assessment estimates. The second assessment estimate may be different from at least one of the plurality of assessment estimates.

The method may further include: receive, from the user device, an indication of termination of the service for the mobility device; and receiving, from the second server, a second assessment estimate that reflects the termination of the service.

The method may further include: sending, to the user device, the second assessment estimate; receiving, from the user device, an indication of approval of the second assessment estimate; and sending, to the second server, information about the indication of approval of the second assessment estimate.

The features of the present disclosure, which are briefly summarized herein, are only examples of aspects of features of the present disclosure and detailed description of the disclosure which follows and are not intended to limit the scope of the present disclosure.

The technical problems solved by the present disclosure are not limited to the above-mentioned technical problems. Other technical problems solved by the present disclosure, which are not described herein should be more clearly understood by a person having ordinary skill in the art of technical field to which the present disclosure belongs, from the following description.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram illustrating devices that constitute an assessment management system for a value-fluctuated mobility device communicating with each other to transmit and receive data;

FIG. 2 is a diagram illustrating modules included in a first server and a second server of an assessment management system according to the present disclosure;

FIG. 3 is a flowchart illustrating a process in which a first server provides an assessment estimate upon a request for an assessment estimate for a mobility device;

FIG. 4 is a flowchart illustrating a process in which a first server provides an assessment estimate reflecting an additional service upon a request for an additional service of a mobility device;

FIG. 5 is a flowchart illustrating a process in which a first server provides assessment estimates received from multiple second servers;

FIG. 6 is a flowchart illustrating a process in which a first server provides an assessment estimate reflecting the termination of a service upon termination of a mobility device's service;

FIG. 7 is a flowchart illustrating a process in which a second server provides an assessment estimate upon a request for an assessment estimate;

FIG. 8 is a flowchart illustrating a process in which a second server provides an assessment estimate reflecting an additional service upon a decision to purchase an additional service of a mobility device; and

FIG. 9 is a flowchart illustrating a process in which a second server provides an assessment estimate reflecting the termination of a service upon termination of a service of a mobility device.

### DETAILED DESCRIPTION

Herein after, examples of the present disclosure are described in detail with reference to the accompanying drawings so that those having ordinary skill in the art may easily implement the present disclosure. However, examples of the present disclosure may be implemented in various different ways and thus the present disclosure is not limited to the examples described therein.

In describing examples of the present disclosure, well-known functions or constructions have not been described in detail since a detailed description thereof may have unnecessarily obscured the gist of the present disclosure. The same constituent elements in the drawings are denoted by the same reference numerals and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the ways of attaining them should become apparent to those of ordinary skill in the art with reference to examples of the present disclosure described below in detail in conjunction with the accompanying drawings. The examples of the present disclosure, however, may be embodied in many different forms and should not be constructed as being limited to the example examples set forth herein. Rather, the examples described herein are provided to make this disclosure more complete and to fully convey the scope of the present disclosure to those having ordinary skill in the art to which the present disclosure pertains.

In the present disclosure, each of phrases such as “A or B”, “at least one of A and B”, “at least one of A or B”, “A, B or C”, “at least one of A, B and C”, and each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and when drawings illustrated in the present specification are inversed, the location relations described in the specification may be inversely understood. When a component, device, element, or the like of the present disclosure is described as having a purpose or performing an operation, function, or the like, the component, device, or element should be considered herein as being “configured to” meet that purpose or perform that operation or function.

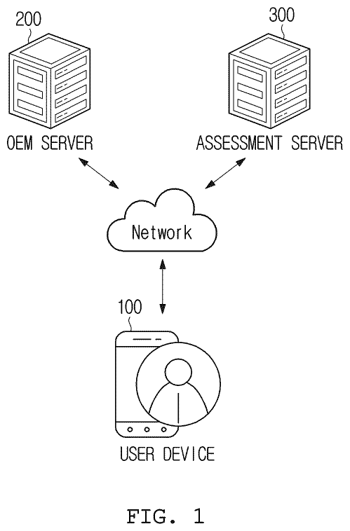

FIG. 1 is a diagram illustrating devices that constitute an assessment management system for a value-fluctuating mobility device communicating with each other to transmit and receive data.

The assessment management system for a value-fluctuating mobility device includes a user device 100, an original equipment manufacturer (OEM) server 200 (e.g., a first server), and an assessment server 300 (e.g., a second server). The OEM server 200, for example, may be a server that is owned, operated, and/or managed by a manufacturer of a mobility device (e.g., a vehicle). The assessment server 300, for example, may be a server that is owned, operated, and/or managed by an entity different from the manufacturer of the mobility device. The entity may, for example, provide services to the mobility device and/or its user based on the value of the mobility device. For example, the service may be a financial service such as insurance. However, the service may not be limited in such a way and can be any type of service that takes into account the value of the mobility vehicle. Each component is not an essential component, and may have additional components or be omitted, and one component may be included in or combined with another component so that a single component may perform multiple functions. Each component may communicate with each other through a wired or wireless network.

The mobility device may be a vehicle propelled by electric energy or fossil energy. In the case of electric energy, the mobility device may be, for example, a pure battery-based mobility driven only by a high-voltage battery or may employ a gas-based fuel cell as an energy source. In addition, the fuel cell may utilize various forms of gas capable of generating electric energy, and the gas may be hydrogen, for example. However, the present disclosure is not limited thereto, and various gases may be applied. In the case of fossil energy, the mobility device may be driven by fuel such as gasoline, diesel, or liquefied gas.

A mobility device may refer to a moving body that can physically move in a space. Specifically, a mobility device is a vehicle that is a ground moving body that runs on the ground, and may be a typical passenger or commercial vehicle, a purpose-built vehicle (PBV), etc. The mobility device 100 may be a four-wheeled vehicle, such as a passenger car, an SUV, or a small truck, and may be a vehicle with more than four wheels, such as a bus, a large truck, a container transport vehicle, a heavy equipment vehicle, etc. In addition, the mobility device may include an airborne vehicle, such as an airplane, a drone, or a helicopter, and may also include a vehicle that can move through the sea, such as a ship or a submarine, without being limited thereto.

The value-fluctuating mobility device according to the present disclosure may be a moving body as described above, to which a software-defined vehicle (SDV) business model is applied. The SDV business model refers to a business model in which functions and services implemented in a mobility device are provided in the form of software, and a customer may set up the mobility device by determining whether to subscribe to such functions and services.

The functions of the value-fluctuating mobility device may be updated over-the-air (OTA) after purchase, or the customer may select and purchase and apply desired services in the form of software. The service may be a feature-on-demand (FOD). The service may be a subscription service. The value of the mobility device may continuously fluctuate and may be different from the value of the mobility device when the new vehicle was purchased.

The user device 100 may refer to a mobile computing device equipped with hardware and software capable of a request for an assessment estimate, a third-party provision consent of information used in the present disclosure, and assessment subscription, as a communication device. An assessment may be an insurance, and an assessment estimate may be an insurance quote. For example, the user device 100 may include a mobile phone, a smartphone, and a wearable device. In addition, the user device is limited to the above examples, and may include any electronic device capable of network communication with the OEM server 200 and the assessment server 300 via wired or wireless communication, such as a notebook, a laptop, a tablet PC, etc.

The user device 100 according to one embodiment of the present disclosure may request an assessment estimate from the OEM server 200 upon subscription to new assessment or expiration of assessment, and at the same time as requesting the assessment estimate, may provide consent information for sharing information required to calculate the assessment estimate from the assessment server 300 of the assessment company to the OEM server. In addition, the user device 100 according to one embodiment of the present disclosure may provide information on a request for an assessment estimate reflecting an additional service and consent information for sharing information required to calculate the assessment estimate to the OEM server 200, in response to a request for the additional service for the mobility device.

Specifically, the information required to calculate the assessment estimate may include attribute information of the mobility device. The attribute information of the mobility device may include information on a service to which the mobility device is subscribed. For example, the attribute information of the mobility device may include information on a service related to the specifications of the mobility device, such as software (e.g., an autonomous driving system, a remote smart parking assistance system, an infotainment system, a lane keeping assistance system, etc.) and hardware (lidar, a floating headlight, etc.) installed in the mobility device, and information on services such as a pick-up service and an emergency dispatch service. More specifically, the attribute information of the mobility device may also include information on a service related to the above-described specifications, whether to subscribe to the service, a subscription period, or a value. For example, the attribute information may include information on the usage period of software for autonomous driving Lv. 3 and the corresponding fee. In addition, the attribute information of the mobility device may include information on the final value of the mobility device according to the application of the above-described service. In addition, the attribute information of the mobility device may include all information that affects the final value of the mobility device, such as repair history due to an accident and depreciation history. The attribute information may indicate that a service of at least one device part (e.g., an autonomous driving system, a remote smart parking assistance system, an infotainment system, a lane keeping assistance system, etc.) of the mobility device is associated with at least one of an accident risk value or a user convenience value of the mobility device. The accident risk value may indicate a level of risk for an accident occurring. The accident risk value may indicate, for example, a safety rating of the mobility device. The accident risk value may be used to determine an assessment estimate. The user convenience value may indicate service for user convenience. For example, the user convenience value may include an infotainment system, pick-up service and an emergency dispatch service. The user convenience value may be used to determine an assessment estimate.

In addition, the information required to calculate the assessment estimate may include assessment information of the previous assessment by the owner of the mobility device. The assessment information may include assessment details that have changed in the past or present due to subscription to additional services of the mobility device or termination of services (for example, details of assessment premium increase/decrease due to subscription to additional services of the mobility device or termination of services, assessment premium payment details, assessment period details, and information on assessment decisions) and information required from an assessment company to subscribe to assessment (for example, approval and consent for an assessment estimate calculated by the assessment company or payment of assessment premium). In other words, the assessment information may include assessment details including all details related to assessment subscribed by the owner, such as information on assessment decisions such as approval (e.g., acceptance) or decision on an assessment estimate, assessment premium payment details that may be considered as an assessment decision, etc.

The user device 100, the OEM server 200, and the assessment server 300 may communicate with each other via a network. The network may be implemented with any form of digital data communication and may include various wired and wireless communications, such as a local area network (LAN), a wide area network (WAN), 3G, 5G, Wi-Fi, and LTE.

The OEM server 200 may be a main server operated by a manufacturer that manufactures a mobility device, and the OEM server 200 may transmit various information and software modules used to control the mobility device to the mobility device or the user device 100 in response to requests and data transmitted from the mobility device and the user device 100, in order to support autonomous driving and various services of the mobility device. In the present disclosure, the main server is specifically referred to as the OEM server 200 and described, but a server to which an assessment management method for a value-fluctuating mobility device according to the present disclosure may be applied is not limited to the OEM server 200, which is one embodiment of the main server.

The OEM server 200 according to the present disclosure may act as an intermediary for sharing and providing information on assessment contracts between the assessment server 300 of an assessment company and the user device 100. For example, it may perform attribute information provision of a mobility device, assessment information inquiry and provision, changed assessment detail storage, etc. in order to calculate the assessment estimate. This will be described later.

The assessment server 300 may specifically mean a server of an assessment company, and although it is illustrated as a single server in FIG. 1, it is not limited thereto, and since different assessment servers 300 exist for each assessment company, the assessment server 300 may include a plurality of assessment servers 300. The assessment server 300 according to the present disclosure may calculate an assessment estimate according to addition, change, and termination of a service, or calculate an assessment estimate according to a case where there is no change in an existing service but an assessment subscription period has expired and the assessment is renewed, or new assessment is subscribed. This will be described later. The assessment estimate may be determined based on at least one of an accident risk value or a user convenience value of a mobility device.

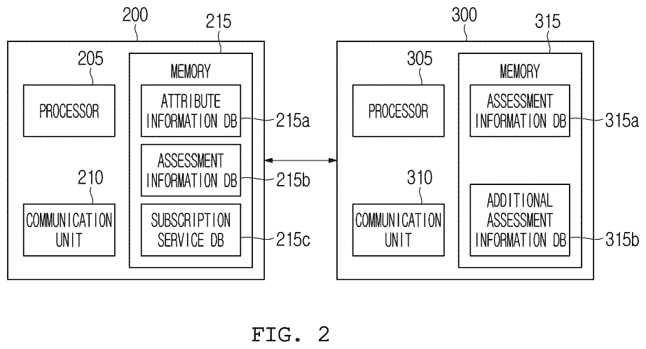

FIG. 2 is a diagram illustrating modules included in an OEM server and an assessment server of an assessment management system according to the present disclosure.

The OEM server 200 may include a processor 205, a communication unit 210, and a memory 215, and the memory 215 may include an attribute information DB 215a, an assessment information DB 215b, and a service DB 215c. The assessment server 300 may include a processor 305, a communication unit 310, and a memory 315, and the memory 315 may include an assessment information DB 315a and an additional assessment information DB 315b. Each component included in the OEM server 200 and the assessment server 300 is not an essential component, may have additional components or may be omitted, and a single component may be included in or combined with another component so that a single component may perform multiple functions. For example, the assessment information DB 315a and additional assessment information DB 315b of the assessment server 300 may be combined to comprehensively manage assessment details according to assessment information, changed assessment details, and attribute information of the mobility device. In addition, the communication unit 310 of the assessment server 300 may be referred to as a transceiver.

The communication unit 210 of the OEM server 200 and the communication unit 310 of the assessment server 300 may transmit and receive information required to calculate an assessment estimate. The communication units 210 and 310 may use a network implemented with any form of digital data communication to transmit and receive the information, and may use various wired and wireless communications such as a local area network (LAN), a wide area network (WAN), 3G, 5G, Wi-Fi, and LTE.

The memory 215 of the OEM server 200 may store an application and various data for controlling the OEM server 200, and load the application or read and write the data at the request of the processor 205. In one embodiment of the present disclosure, the memory 215 may store an application and at least one instruction for receiving a request for an assessment estimate from the user device 100, providing attribute information of a mobility device, to which a service is applied, to the assessment server 300, receiving the assessment estimate from the assessment server 300, sending the assessment estimate to the user device, receiving an assessment decision from the user device 100 and sending assessment information including information on the assessment decision to the assessment server. An assessment decision may be an indication (e.g., a message) of approval of an assessment estimate.

The processor 205 of the OEM server 200 and the processor 305 of the assessment server 300 may perform overall control of each server 200, 300. The processor 205, 305 of each server 200, 300 may be configured to execute applications and instructions stored in the memory 215, 315 of each server 200, 300.

The attribute information DB 215a of the OEM server 200 may store the attribute information of the mobility device, and specifically, may store the attribute information of the mobility device corresponding to the owner of the mobility device. For example, information on a subscribed service applied to the mobility device linked to the user device 100, that is, according to the owner of the user device 100, may be stored. The assessment information DB 215b may store information required to calculate an assessment estimate, and store assessment information of a previous assessment matching the owner of the mobility device. The assessment estimate may be determined based on at least one of an accident risk value user convenience value of a mobility device. The service DB 215c may store information on a service applicable to the mobility device, and may provide information on an applicable service when the owner of the mobility device wants to purchase an additional service in the future.

The assessment information DB 315a of the assessment server 300 may store information required to calculate the assessment estimate for the mobility device, and for example, may include attribute information and assessment information of the mobility device corresponding to the owner of the mobility device. The additional assessment information DB 315b may store information required to calculate the assessment estimate when an additional service is applied to the mobility device.

For convenience of explanation below, processing in each module is collectively referred to as processing of the OEM server 200 and the assessment server 300.

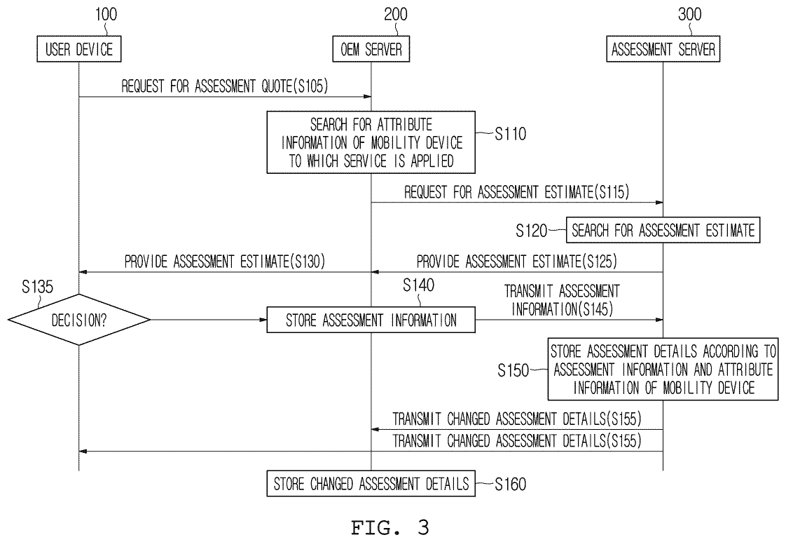

FIGS. 3 to 6 are diagrams illustrating a process of calculating an assessment estimate through the OEM server 200 according to one embodiment of the present disclosure.

FIG. 3 is a flowchart illustrating a process in which an OEM server provides an assessment estimate upon a request for an assessment estimate due to new subscription or expiration of assessment for a mobility device.

Referring to FIG. 3, the user device 100 automatically requests an assessment estimate for the mobility device from the OEM server 200 (S105). Specifically, when a new subscription, expiration, or renewal of assessment for the mobility device is required, the OEM server 200 automatically requests a response to the request for an assessment estimate from the user device 100. Accordingly, the user device 100 transmits to the OEM server 200 not only the request for the assessment estimate, but also information on a third-party provision consent of information required to calculate the assessment estimate.

Based on an opt-in method, if the OEM server 200 acquires the consent to provide information to a third party and the request for the assessment estimate from the user device 100, the OEM server 200 searches for the attribute information of the mobility device to which a service is applied (S110). In addition, based on an opt-out method, the OEM server 200 may first provide information to the third party and then stop the processing of searching for the attribute information of the mobility device to calculate the assessment estimate if a refusal to provide information is received from the owner. Hereinafter, the description is based on consent to provide information to the third party by the opt-in method.

The OEM server 200 searches for a service currently applied to the mobility device, and more specifically, searches for a service related to specifications such as the type of software and type of hardware installed in the mobility device, and information about subscription periods or values for services such as pickup service and emergency dispatch service.

In addition, the OEM server 200 may search for the assessment information of the previous assessment for the mobility device when an assessment estimate is requested due to expiration or renewal of the assessment of the mobility device. This is to reflect the increase or decrease in the assessment premium or discount when calculating the assessment estimate due to renewal or expiration.

Next, the OEM server 200 requests the assessment estimate from the assessment server 300 (S115). Specifically, the OEM server 200 may transmit the searched attribute information of the mobility device based on the consent of the owner of the mobility device to provide information to the third party. In addition, assessment information may be transmitted to the assessment server 300 according to the expiration or renewal of assessment of the mobility device.

Next, the assessment server 300 searches for the assessment estimate to provide the assessment estimate to the OEM server 200 (S120). The assessment server 300 may refer to the received mobility attribute information to calculate the assessment estimate, and in case of calculating the assessment estimate due to renewal or expiration, may refer to the assessment information of the previous assessment of the mobility device and the attribute information of the owner's mobility device that is previously stored in the assessment server 300.

For example, if a service such as a lane keeping assist system or an autonomous driving system is applied to the mobility device, a discount according to the application of safety specifications may be reflected in the assessment estimate. In addition, if the service described above is expected to expire within the assessment period (e.g., from the start date of assessment subscription due to new subscription or renewal to the expiration date), the assessment server 300 may calculate a different assessment estimate during the assessment period.

Next, the assessment server 300 provides the assessment estimate calculated by the above-described process to the OEM server 200 (S125). In addition, the assessment server 300 may directly transmit the calculated assessment estimate to the user device 100. In addition, since each assessment company has a separate assessment server 300, the assessment server 300, which has obtained the third-party provision consent from the user device 100, may individually calculate the assessment estimate and provide the assessment estimate.

Next, the OEM server 200 transmits the received assessment estimate to the user device 100 and requests a response regarding the assessment decision (S130). Next, the user device 100 makes an assessment decision and transmits it to the OEM server (S135). Specifically, the owner may transmit information regarding approval or rejection of the provided assessment estimate to the OEM server through the user device 100. The owner may not only approve the assessment estimate but also pay the assessment premium for the assessment estimate to the OEM server 200 through the user device 100.

Next, the OEM server 200 stores the assessment information including information on the received assessment decision and/or assessment premium payment details (S140) and transmits the assessment information to the assessment server 300 (S145). Specifically, the OEM server 200 may transmit the assessment information and at the same time transmit the assessment premium paid through the OEM server 200 to the assessment server 300. Alternatively, the OEM server 200 may transmit the assessment premium payment details to the assessment server 300.

Next, the assessment server 300 stores assessment details according to the assessment information and attribute information of the mobility device (S150). Specifically, the assessment server 300 stores assessment details such as information on assessment decision, assessment premium payment details, and assessment period details, and stores attribute information of the owner's mobility device that is referred to in calculating the assessment estimate. Accordingly, when renewal is required later due to expiration of the assessment, the assessment server 300 may automatically refer to the previous assessment details or attribute information of the mobility device to calculate the assessment estimate.

The assessment server 300 transmits the changed assessment details to the OEM server 200 and the user device 100 as the assessment subscription is completed according to the assessment decision (S155). Similarly, the OEM server 200 stores the changed assessment details to enable the user device 100 to manage the response to the request for the assessment estimate when renewal is required due to expiration of the assessment (S160).

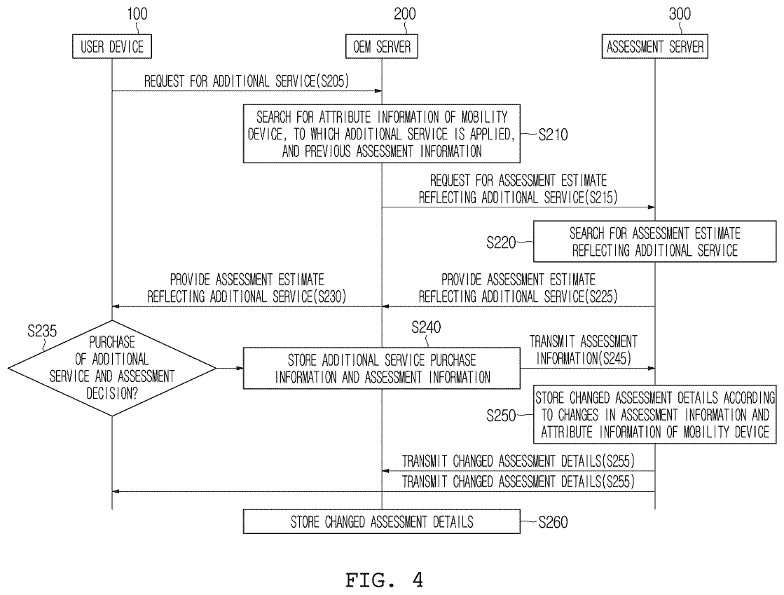

Hereinafter, a process of renewing the previous assessment based on an additional service when the owner of the mobility device requests the additional service from the OEM server 200 within a period of the previous assessment will be described with reference to FIG. 4.

FIG. 4 is a flowchart illustrating a process in which an OEM server provides an assessment estimate reflecting an additional service upon a request for an additional service of a mobility device.

When a request for an additional service of a mobility device is received through the user device 100 (S205), the OEM server 200 searches for attribute information of the mobility device, to which the additional service is applied, and previous assessment information (S210). As described in FIG. 3, the user device 100 may transmit information on a third-party provision consent of information required to calculate the assessment estimate to the OEM server 200 as renewal of assessment is required due to purchase of the additional service.

The attribute information of the mobility device, to which the additional service is applied, may include information on whether to apply the service of software such as an autonomous driving system and a remote smart parking assistance system and hardware such as a lidar, and may include information on the final value of the mobility device according to the value and application of the software and hardware. The final value may refer to the expected vehicle value.

Next, the OEM server 200 requests an assessment estimate reflecting the additional service to the assessment server 300 (S215). The OEM server 200 may transmit the attribute information of the mobility device, to which the additional service is applied, to calculate the assessment estimate.

Next, the assessment server 300 searches for the assessment estimate reflecting the additional service (S220). The assessment server 300 may refer to the attribute information of the mobility device, to which the additional service is applied, to calculate the assessment estimate, and may refer to the previous assessment information of the mobility device and the attribute information of the owner's mobility device that is previously stored in the assessment server 300.

For example, if services such as lane keeping assist system and autonomous driving system are not applied and thus the discount due to application of safety specifications is not applied as a result of referring to the previously stored attribute information of the mobility device, the assessment server 300 may reflect the discount in the assessment estimate by applying the above-described service to the mobility vehicle as an additional service.

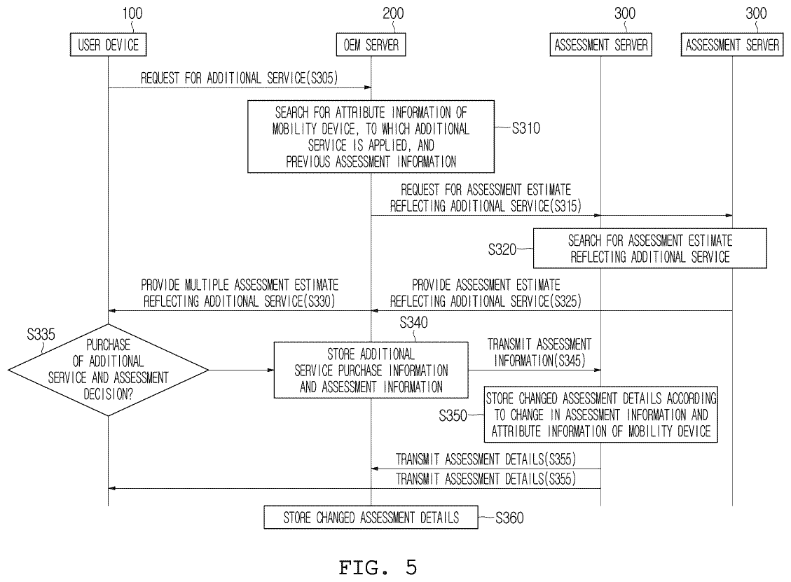

Next, the assessment server 300 provides the assessment estimate reflecting the additional service calculated by the above-described process to the OEM server 200 (S225). In addition, the assessment server 300 may directly transmit the calculated assessment estimate to the user device 100. In addition, since each assessment company has a separate assessment server 300, the assessment server 300, which has obtained the third-party information provision consent from the user device 100, may individually calculate the assessment estimate reflecting the additional service and provide the assessment estimate. This will be described in detail with reference to FIG. 5.

Next, the OEM server 200 transmits the assessment estimate reflecting the received additional service to the user device 100 and requests a response regarding the purchase of the additional service and the assessment decision (S230). Next, the user device 100 responds to the OEM server 200 regarding the purchase of the additional service and the assessment decision (S235).

Specifically, the owner may transmit information on the purchase of the additional service and approval or rejection of the assessment estimate reflecting the additional service to the OEM server 200 through the user device 100. For assessment renewal due to the purchase of the additional service, the user device 100 may pay the assessment premium for the assessment estimate to the OEM server 200, and pay the fee for the purchase of the additional service to the OEM server 200.

Next, the OEM server 200 stores information on the purchase of the additional service and the assessment information (S240) and transmits the assessment information to the assessment server 300 (S245). Specifically, the OEM server 200 may transmit the assessment information and the assessment premium paid through the OEM server 200 to the assessment server 300 at the same time. Alternatively, the OEM server 200 may transmit the assessment premium payment details to the assessment server 300. In addition, the OEM server 200 may transmit information on the purchase details of the additional service to the assessment server 300.

Next, the assessment server 300 stores assessment details according to changes in assessment information and the attribute information of the mobility device (S250). Specifically, the assessment server 300 stores assessment details such as information on assessment decisions due to purchase of the additional service, assessment premium payment details, and assessment period details, and stores attribute information of the mobility device reflecting the additional service referred to in calculating the assessment estimate.

As the assessment contract change due to the purchase of the additional service is completed, the assessment server 300 transmits the changed assessment details to the OEM server 200 and the user device 100 (S255). Similarly, the OEM server 200 stores the changed assessment details to enable the user device 100 to manage a response to the request for the assessment estimate when assessment renewal is required later (S260).

Hereinafter, a process of requesting an assessment estimate from the assessment server 300 of each assessment company will be described through FIG. 5.

FIG. 5 is a flowchart illustrating a process in which an OEM server provides assessment estimates received from multiple assessment servers.

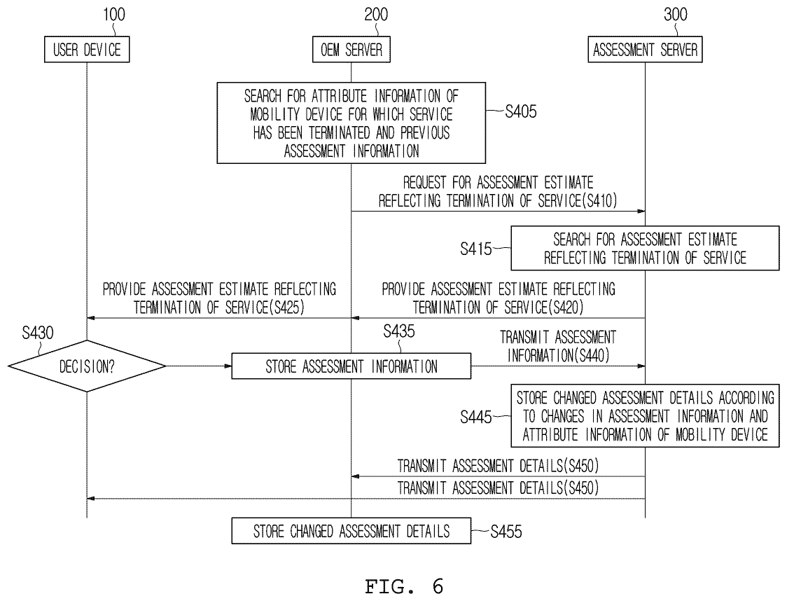

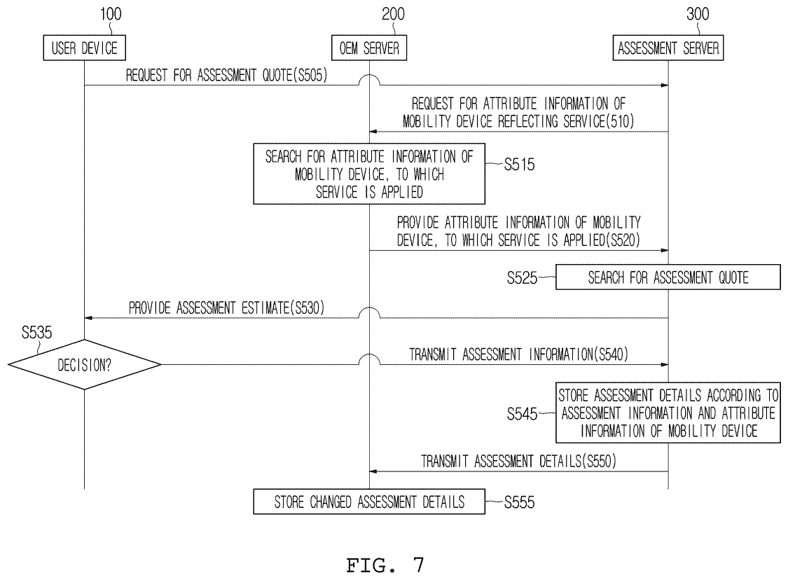

FIG. 5 mainly shows a process of providing assessment estimates received from multiple assessment servers upon a request for an additional service, but the present disclosure is not limited thereto and may be equally applied to a process of providing an assessment estimate upon renewal due to new subscription, termination, expiration, or termination of a service, which will be described later via FIG. 6. In addition, the present disclosure may be substantially equally applied to a process in which an assessment server provides an assessment estimate, which will be described via FIGS. 7 to 9.

When a request for an additional service of a mobility device is received through the user device 100 (S305), the OEM server 200 searches for attribute information of the mobility device, to which the additional service is applied, and previous assessment information (S310). Specifically, the user device 100 may selectively designate the scope of the third-party provision consent when transmitting information on the third-party provision consent of information required to calculate the assessment estimate to the OEM server 200.

For example, if the user device 200 does not have a separate designation for the scope of the third-party provision consent, the OEM server 200 may set the scope of information provision to a previous assessment company as the default value. On the other hand, if there is no existing assessment company, or if the user wants to receive an assessment estimate in addition to an existing assessment company, the user device 100 may designate an assessment company from which to request an assessment estimate and transmit information on third-party provision consent for the designated assessment company to the OEM server 200.

Next, the OEM server 200 requests an assessment estimate reflecting the additional service from the assessment server 300 of the assessment company with which the third-party provision consent has been made (S315). Subsequently, each assessment server 300 searches for the assessment estimate reflecting the additional service (S320). The process in which each assessment server 300 refers to the attribute information of the mobility device to calculate the assessment estimate is substantially the same as the S220 process in FIG. 4.

Next, each assessment server 300 provides the assessment estimate reflecting the additional service calculated thereby to the OEM server 200 (S325). In addition, each assessment server 300 may directly transmit the calculated assessment estimate to the user device 100.

The OEM server 200 transmits the assessment estimate reflecting the received additional service to the user device 100 and requests a response regarding the purchase of the additional service and the assessment decision (S330). Upon receiving multiple assessment estimates, the user device 100 selects an assessment company to subscribe to assessment with, as well as whether to purchase the additional service and the assessment decision (S335). The processing regarding the purchase of the additional service and the assessment decision is substantially the same as step S235 of FIG. 4.

Next, the OEM server 200 stores information on the purchase of the additional service and assessment information (S340), and transmits the assessment information to the assessment server 300 of the assessment company with which the user device 100 has decided to subscribe to the assessment (S345). The process of sending the assessment information to the assessment server 300 according to the assessment company selected by the user device 100 is substantially the same as step S245 of FIG. 4.

The assessment server 300 of the assessment company designated according to the selection of the user device 100 stores the assessment details according to the change in assessment information and the attribute information of the mobility device (S350). The process of storing the above-described information by designating the assessment server 300 of the previous assessment company is substantially the same as step S250 of FIG. 4. On the other hand, if the user device 100 selects a new assessment company other than the previous assessment company, the assessment details according to initial assessment information, not the assessment details according to the change in assessment information, are stored. In other words, the assessment details may be stored as assessment information according to the initial subscription format, not the change in assessment details.

The assessment server 300 transmits the changed assessment details to the OEM server 200 and the user device 100 as the assessment subscription is completed according to the assessment decision (S355). Similarly, the OEM server 200 stores the changed assessment details to enable the user device 100 to manage the response to the request for the assessment estimate when a renewal is required due to expiration of the assessment (S360).

Next, a process in which the OEM server 200 requests an assessment estimate when a change in mobility device assessment is required due to the termination of a service will be described.

FIG. 6 is a flowchart illustrating a process in which an OEM server provides an assessment estimate reflecting the termination of a service upon termination of a mobility device's service.

For example, when signing up for assessment, a discount is reflected in an assessment premium based on application of a service, but if the discount ends later during an assessment period due to the termination or expiration of the service, renewal of the assessment is required.

In the above case, the OEM server 200 searches for attribute information of the mobility device for which the service has been terminated and previous assessment information to renew assessment upon termination of the service (S405).

Specifically, the OEM server 200 may search for the above information in real time without requesting an assessment estimate through the user device 100 due to termination of the service. Specifically, the OEM server 200 search for information about a final value of the mobility device due to termination of application of software or hardware previously applied to the mobility device as attribute information of the mobility device for which the service has been terminated.

Next, the OEM server 200 requests assessment estimate reflecting the termination of the service from the assessment server 300 (S410). The OEM server 200 may transmit attribute information of the mobility device, for which the service has been terminated, to calculate the assessment estimate.

Upon receiving the request for the assessment estimate, the assessment server 300 searches for the assessment estimate reflecting the termination of the service (S415). The assessment server 300 may refer to the attribute information of the mobility device, for which the service has been terminated, in order to calculate the assessment estimate, and may refer to information on the previous assessment for the mobility device and the attribute information of the owner's mobility device that is previously stored in the assessment server 300.

For example, the assessment server 300 may calculate an assessment estimate requiring additional assessment premium payment for the remaining assessment period compared to the previously calculated assessment estimate due to termination of the service, such as a previously applied lane keeping assist system or autonomous driving system, by referring to the previously stored attribute information of the mobility device.

The assessment 300 provides the assessment estimate reflecting the termination of the service calculated by the process described above to the OEM server 200 (S420). In addition, since each assessment company has a separate assessment server 300, the assessment server 300, which has obtained third-party information provision consent from the user device 100, may individually calculate the assessment estimate reflecting the termination of the service and provide the assessment estimate.

In order to receive the assessment estimate individually from each of the assessment servers 300 of multiple assessment companies, the OEM server 200 may request the scope of the third-party provision consent from the user device 100. In addition, the OEM server 200 may already have the scope of the third-party provision consent, in order to automatically request the assessment estimate from the assessment server 300 and provide it to the user device 100 upon termination of the service.

Next, the OEM server 200 transmits the assessment estimate reflecting the termination of the service to the user device 100 and requests a response regarding an assessment decision for the assessment estimate reflecting the termination of the service (S425). Next, the user device 100 sends the assessment decision to the OEM server 200 (S430).

In addition, the user device 100 may pay or receive a refund for the increase or decrease in assessment premium due to the termination of the service through the OEM server 200. Specifically, if the application of the safety specification discount is terminated due to the expiration of the autonomous driving system, the user device 100 may pay the additional assessment premium to the OEM server 200 upon being requested to pay the additional assessment premium through the assessment estimate.

Next, the OEM server 200 stores the assessment information (S435) and transmits the assessment information to the assessment server 300 (S440). Specifically, the OEM server 200 may transmit the assessment information and at the same time transmit the assessment premium paid through the OEM server 200 to the assessment server 300. Alternatively, the OEM server 200 may transmit the assessment premium payment details to the assessment server 300.

The assessment server 300 stores assessment details according to changes in assessment information and the attribute information of the mobility device (S445). Specifically, the assessment server 300 stores assessment details such as information on assessment decisions due to termination of service, assessment premium payment details, assessment period details, and changes in assessment premium, and stores the attribute information of the mobility device for which the service referred to in calculating the assessment estimate has been terminated.

The assessment server 300 transmits the changed assessment details to the OEM server 200 and the user device 100 as the change in the assessment contract is completed due to the termination of the service (S450). Similarly, the OEM server 200 stores the changed assessment details to enable the user device 10 to manage the response to the request for the assessment estimate when assessment renewal is required later (S455).

Hereinafter, a process of calculating an assessment estimate through the assessment server 300 according to another embodiment of the present disclosure will be described with reference to FIGS. 7 to 9.

FIG. 7 is a flowchart illustrating a process in which an assessment server provides an assessment estimate upon a request for an assessment estimate due to a new subscription or expiration of assessment for a mobility device.

Referring to FIG. 7, the user device 100 requests an assessment estimate for the mobility device from the assessment server 300 (S505). Specifically, when a new subscription, expiration, or renewal of assessment for the mobility device is required, the assessment server 300 automatically requests a response to the request for the assessment estimate from the user device 100. In addition, the user device 100 may transmit information on third-party information provision consent to the assessment server 300 so that the assessment server 300 may obtain information required to calculate the assessment estimate from the OEM server 200.

When receiving the request for the third-party information provision consent and for the assessment estimate from the user device 100, the assessment server 300 requests the attribute information of the mobility device, to which the service is applied, from the OEM server 200 to calculate the assessment estimate (S510).

The OEM server 200 searches for the attributes of the mobility device, to which the service is applied, according to the request described above from the assessment server 300 (S515). Specifically, similar to step S110 of FIG. 3, the OEM server 200 searches for information on the types and specifications of software and hardware installed in the mobility device, and subscription periods or values for services such as pickup services and emergency dispatch services.

Subsequently, the OEM server 200 provides the attribute information of the mobility device to which the service is applied (S520).

Next, the assessment server 300 searches for the assessment estimate to provide the assessment estimate to the user device 100 (S525). The assessment server 300 may refer to the received mobility attribute information to calculate the assessment estimate.

In addition, in the case of calculating the assessment estimate due to renewal or expiration of assessment, the assessment server 300 may refer to the previous assessment information for the mobility device and the attribute information of the owner's mobility device previously stored in the assessment server 300 to reflect the increase or decrease in the assessment premium or discount.

For example, in the assessment server 300 according to another embodiment of the present disclosure, similar to the case where the OEM server 200 according to the embodiment of the present disclosure calculates the assessment estimate, when a service such as a lane keeping assist system, an autonomous driving system, etc. is applied to the mobility device, a discount according to application of safety specifications may be reflected in the assessment estimate. In addition, when the service described above is expected to expire within the assessment period (e.g., from the start date of assessment subscription due to new subscription or renewal to the expiration date), the assessment server 300 may calculate a different assessment estimate during the assessment period.

Next, the assessment server 300 provides the calculated assessment estimate to the user device 100 (S530). The user device 100 makes an assessment decision on the received assessment estimate and sends a response to the assessment server 300 (S535, S540).

Specifically, the user device 100 transmits information on approval or rejection of the provided assessment estimate to the assessment server 300. In addition, the user device 100 may transmit information on assessment premium or assessment premium payment details for the assessment estimate to the assessment server 300.

Next, the assessment server 300 stores assessment details according to the assessment information and the attribute information of the mobility device (S545). Specifically, the assessment server 300 stores such assessment details as information on assessment decisions, assessment premium payment details, and assessment period details, and stores the attribute information of the owner's mobility device that is referred to in calculating the assessment estimate. Accordingly, when re-renewal is required later due to expiration of the assessment, the assessment server 300 may automatically refer to the previous assessment details or the attribute information of the mobility device to calculate the assessment estimate.

The assessment server 300 transmits the changed assessment details to the OEM server 200 as the assessment subscription is completed according to the assessment decision (S550). Similarly, the OEM server 200 stores the changed assessment details to enable the device 100 to manage the response to the request for the assessment estimate when renewal is required later due to expiration of the assessment (S555).

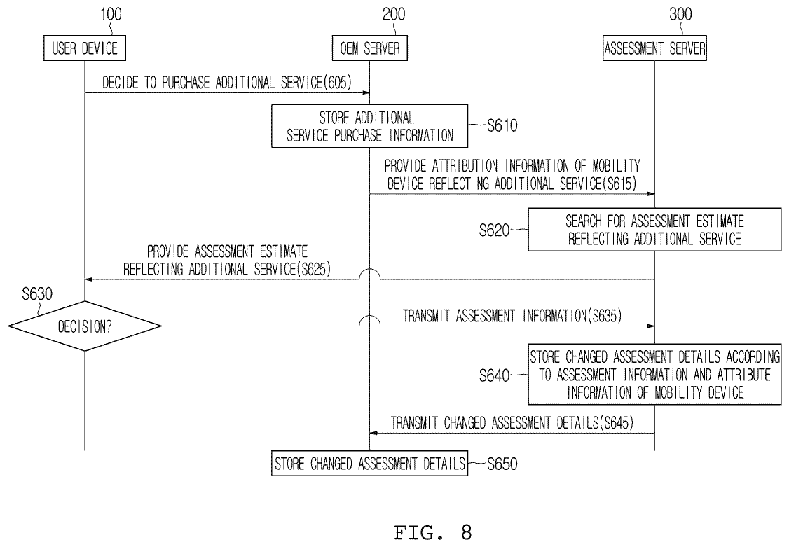

Hereinafter, a process in which the assessment server 300 renews the previous assessment based on the additional service when the owner of the mobility device requests an additional service from the OEM server 200 within the previous assessment period will be described with reference to FIG. 8.

FIG. 8 is a flowchart illustrating a process in which an assessment server provides an assessment estimate reflecting an additional service upon a decision to purchase an additional service of a mobility device.

As the user device 100 decides to purchase an additional service (S605), the OEM server 200 stores additional service purchase information (S610).

Specifically, the user device 100 transmits, to the OEM server 200, the additional service purchase information and information on a third-party provision consent of information required to calculate an assessment estimate as assessment renewal is required according to subscription to the additional service.

Next, the OEM server 200 provides attribute information of the mobility device, to which the additional service is applied, to the assessment server 300 based on the third-party provision consent received from the user device 100 (S615). Specifically, if the scope of the third-party provision consent is designated from the user device 100, the OEM server 200 provides the attribute information of the mobility device, to which the additional service is applied, to the assessment server 300 of the designated assessment company. That is, in order to receive different assessment estimates respectively calculated by the assessment servers 300, the OEM server 200 may provide the attribute information of the mobility device, to which the additional service is applied, for each of the assessment servers 300 of the multiple assessment companies.

Next, when receiving the attribute information of the mobility device from the OEM server 200, the assessment server 300 searches for an assessment estimate reflecting the additional service (S620). Specifically, the assessment server 300 searches for the previous assessment information based on the attribute information of the mobility device to which the received additional service has been applied, and determines whether a change in assessment is required.

For example, if a safety specification discount is applied to the assessment premium due to the purchase of an autonomous driving system and a reduction in the assessment premium is required, the assessment server 300 may determine that a change or renewal of the assessment is required. As another example, if the purchase of an infotainment system does not require an increase or decrease in the assessment premium, the assessment server 300 may determine that a change or renewal of the assessment is unnecessary. Whether or not a change in the assessment is required is not limited to the above examples and may vary according to the regulations of each assessment company and national laws.

Next, the assessment server 300 provides the assessment estimate reflecting the additional service to the user device 100. The assessment server 300 provides the assessment estimate reflecting the additional service to the user device 100, and may request a response from the OEM server 200 regarding the third-party provision consent indicating whether to share the assessment information including the assessment estimate.

Next, the user device 100 makes an assessment decision on the assessment estimate reflecting the additional service and transmits assessment information including information on approval or rejection of the assessment estimate reflecting the additional service to the assessment server 300 (S630, S635). In addition, the user device 100 may also transmit information on the third-party provision consent indicating whether to share the assessment information to the OEM server 200.

Next, the assessment server 300 stores changed assessment details according to the assessment information and the attribute information of the mobility device (S640). Specifically, the assessment server 300 stores assessment details such as information on assessment decisions based on the purchase of additional services, assessment premium payment details, and assessment period details, and stores the attribute information of the mobility device reflecting the additional service referred to in calculating the assessment estimate.

The assessment server 300 transmits the changed assessment details to the OEM server 200 (S645) as the assessment contract change is completed due to the purchase of the additional service. Similarly, the OEM server 200 stores the changed assessment details to enable the user device 100 to manage the response to the request for the assessment estimate when assessment renewal is required later (S650).

Next, a process in which the assessment server 300 provides an assessment estimate when a change in mobility device assessment is required due to the termination of the service will be described.

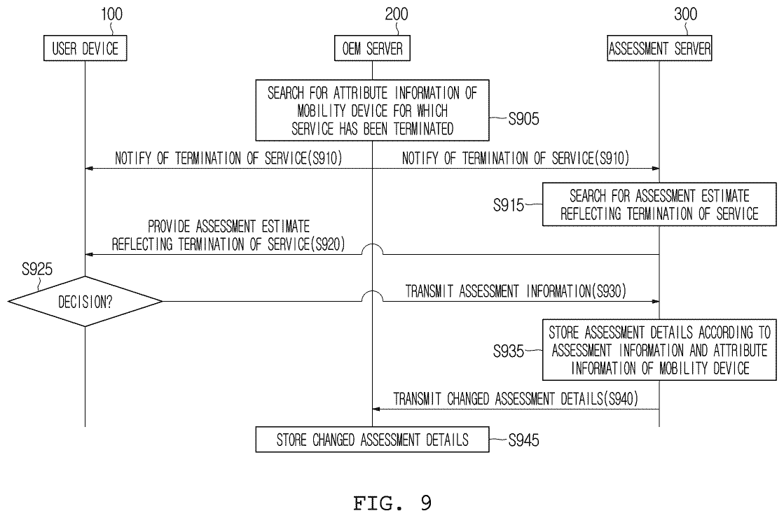

FIG. 9 is a flowchart illustrating a process in which an assessment server provides an assessment estimate reflecting the termination of a service upon termination of a service of a mobility device.

As described in FIG. 6, when signing up for assessment, a discount is reflected in the assessment premium according to the application of the service, but if the discount ends due to the termination or expiration of the service during the assessment period, renewal of the assessment is required.

Accordingly, the OEM server 200 searches for the attribute information of the mobility device for which the service has been terminated in real time (S905), and if there is a mobility device for which the service has been terminated, notifies the user device 100 corresponding to the owner of the mobility device and the assessment server 100 of the assessment company having the assessment, to which the mobility device has subscribed, of the termination of the service (S910). Specifically, the OEM server 200 may notify the assessment server 300 of the termination of the service only when the user device 100 transmits the third-party provision consent to the assessment server 300 of the company as a response.

In addition, if there is a third-party provision consent for automatic notification to the assessment server 300 of the assessment company having the subscribed assessment in the OEM server 200 upon termination of the service, the OEM server 200 may notify the assessment server 300 of the termination of the service without the above response from the user device 100.

The OEM server 200 may notify the assessment server 300 of the termination of the service and transmit the attribute information of the mobility device, for the service has been terminated, to the assessment server 300 in order to calculate the assessment estimate.

Next, when receiving a notification of termination of the service, the assessment server 300 searches for an assessment estimate reflecting the termination of the service (S915). Specifically, the assessment server 300 may search for the attribute information of the mobility device for which the service has been terminated and information on previous assessment. Specifically, the assessment server 200 may search for information on the final value of the mobility device due to the termination of application of software or hardware previously applied to the mobility device as the attribute information of the mobility device for which the service has been terminated. The process in which the assessment server 300 searches for and calculates the assessment estimate is substantially the same as step S415 of FIG. 6.

The assessment server 300 provides the user device 100 with the assessment estimate reflecting the termination of the service calculated by the above-described process (S920). Next, the user device 100 sends an assessment decision to the assessment server 300 (S930).

The user device 100 may pay or receive a refund for the increase or decrease in assessment premium due to the termination of the service through the assessment server 300 according to the assessment decision. Specifically, when the application of the safety specification discount is terminated due to the expiration of the autonomous driving system, the user device 100 may pay the additional assessment premium to the assessment server 300 upon being requested to pay the additional assessment premium through the assessment estimate.

The assessment server 300 stores assessment details according to the change in assessment information and the attribute information of the mobility device (S935). Specifically, the assessment server 300 stores information on assessment decisions due to the termination of the service, details of assessment premium payments, assessment periods, changes in assessment premiums, etc., and stores the attribute information of the mobility device for which the service referred to in calculating the assessment estimate has been terminated.

As the assessment contract change is completed due to the termination of the service, the assessment server 300 transmits the changed assessment details to the OEM server 200 (S940). Similarly, the OEM server 200 stores the changed assessment details to enable the user device 100 to manage the response to the request for the assessment estimate when assessment renewal is required later (S945).

According to the present disclosure, it is possible to provide an assessment management system and method for a value-fluctuating mobility device that manages assessment for a mobility device whose value fluctuates according to addition, change, termination, etc. of a service for the mobility device.

According to the present disclosure, it is possible to provide an automated assessment management system and method that reflects in real time changes in specifications and values due to addition, change, and termination of services for mobility devices after release.

According to the present disclosure, by the automated assessment management system, owners of mobility devices can subscribe to and use assessment estimates that reflect in real time changes in mobility specifications and values without having to submit separate documents or directly contact an assessment company.

According to the present disclosure, in the payment of assessment premiums due to accident occurrence, disputes over payment of assessment premiums due to the value of the mobility device not reflected can be prevented in advance.

According to the present disclosure, by an automated assessment management system, assessment companies can automate tasks requiring separate documentation management and manpower, thereby increasing accuracy and reducing costs.

According to the present disclosure, disputes can be prevented in advance when an accident occurs in the service portion of a mobility device that is not subscribed to automobile assessment.

According to the present disclosure, a mobility device manufacturer can provide an automated assessment management system for renewal and change of automobile assessment caused by a service that is changed after release, thereby increasing convenience for owners and assessment companies.

A main server of an insurance management system for a value-fluctuated mobility device, the main server may comprise: a memory configured to store at least one instruction; and a processor configured to execute the at least one instruction stored in the memory based on data acquired from the memory, wherein the processor may be configured to: provide attribute information of the mobility device, to which a subscription service related to final price calculation of the value-fluctuated mobility device is applied, to an insurance server, receive a first insurance quote calculated based on the subscription service from the insurance server, receive a first insurance decision based on the first insurance quote from a user device, and send information on the first insurance decision to the insurance server.

The processor may be configured to provide the attribute information of the mobility device, to which an additional subscription service is applied, to the insurance server and receive a second insurance quote reflecting the additional subscription service, when receiving a request for the additional subscription service from the user device.

The processor may be configured to send the second insurance quote reflecting the additional subscription service to the user device, receive a second insurance decision based on the second insurance quote from the user device and send information on the second insurance decision according to the additional subscription service to the insurance server.

The insurance server may comprise a plurality of insurance servers, and wherein the processor is configured to selectively receive the second insurance decision on the second insurance quote reflecting a single additional subscription service from the user device as the second insurance quote reflecting the additional subscription service is differently calculated for each of the plurality of insurance servers.

The processor may be configured to provide the attribute information of the mobility device, to which termination of the subscription service is applied, to the insurance server and receive a third insurance quote reflecting the termination of the subscription service from the insurance server, when the subscription service is terminated.

The processor may be configured to send the third insurance quote reflecting the termination of the subscription service to the user device, receive a third insurance decision based on the third insurance quote from the user device, and send information on the third insurance decision according to the termination of the subscription service to the insurance server.

The insurance server may comprise a plurality of insurance servers, and wherein the processor may be configured to selectively receive the third insurance decision on the third insurance quote reflecting termination of a single subscription service from the user device as the third insurance quote reflecting the termination of the subscription service is differently calculated for each of the plurality of insurance servers.

An insurance server of an insurance management system for a value-fluctuated mobility device, the insurance server may comprise: a transceiver configured to transmit and receive a signal; and a processor configured to control the transceiver, wherein the processor is configured to: receive a request for an insurance quote from a user device, receive attribute information of the mobility device, to which a subscription service related to final price calculation of the mobility device is applied, from a main server and provide a first insurance quote to the user device, receive a first insurance decision based on the first insurance quote from the user device, and send information on the first insurance decision to the main server.

The processor may be configured to receive the attribute information of the mobility device, to which an additional subscription service is applied, from the main server, according to a decision to purchase the additional subscription service from the user device and provide a second insurance quote reflecting the additional subscription service to the user device.

The processor may be configured to receive a second insurance decision based on the second insurance quote from the user device and send information on the second insurance decision according to the additional subscription service to the main server.

The insurance server may comprise a plurality of insurance servers, and wherein the processor is configured to enable an insurance server which has calculated the second insurance quote reflecting the selected additional subscription service to selectively receive the second insurance decision from the user device as the second insurance quote reflecting the additional subscription service is differently calculated for each of the plurality of insurance servers.

The processor may be configured to receive the attribute information of the mobility device, to which termination of the subscription service is applied, and provide a third insurance quote reflecting the termination of the subscription service to the user device, as a notification of termination of the subscription service is received from the main server.

The processor may be configured to receive a third insurance decision based on the third insurance quote from the user device and send information on the third insurance decision according to the termination of the subscription service to the main server.

The insurance server may comprise a plurality of insurance servers, and wherein the processor may be configured to enable the insurance server which has calculated a third insurance quote reflecting the termination of the subscription service to receive the third insurance decision from the user device as the third insurance quote reflecting the termination of the subscription service is differently calculated for each of the plurality of insurance servers.

An insurance management method for a value-fluctuated mobility device, the insurance management method may comprise:
providing attribute information of the mobility device, to which a subscription service related to final price calculation of the value-fluctuated mobility device is applied, to an insurance server, receiving a first insurance quote calculated based on the subscription service from the insurance server, receiving a first insurance decision based on the first insurance quote from a user device, and sending information on the first insurance decision to the insurance server.

The insurance management method may further comprise providing the attribute information of the mobility device, to which an additional subscription service is applied, to the insurance server and receiving a second insurance quote reflecting the additional subscription service, when receiving a request for the additional subscription service from the user device.

The insurance management method may further comprise, after receiving the second insurance quote reflecting the additional subscription service, sending the second insurance quote reflecting the additional subscription service to the user device, receiving a second insurance decision based on the second insurance quote from the user device and sending information on the second insurance decision according to the additional subscription service to the insurance server.

The insurance management method wherein the insurance server comprises a plurality of insurance servers, and wherein the receiving the second insurance service comprises selectively receiving the second insurance decision on the second insurance quote reflecting a single additional subscription service from the user device as the second insurance quote reflecting the additional subscription service is differently calculated for each of the plurality of insurance servers.

The insurance management method may further comprise providing the attribute information of the mobility device, to which termination of the subscription service is applied, to the insurance server and receiving a third insurance quote reflecting the termination of the subscription service from the insurance server, when the subscription service is terminated.

The insurance management method may further comprise, after receiving the third insurance quote reflecting termination of the subscription service, sending the third insurance quote reflecting the termination of the subscription service to the user device, receiving a third insurance decision based on the third insurance quote from the user device, and sending information on the third insurance decision according to the termination of the subscription service to the insurance server.

It will be appreciated by persons skilled in the art that that the effects that can be achieved through the present disclosure are not limited to what has been particularly described hereinabove and other advantages of the present disclosure will be more clearly understood from the detailed description.

While the methods of the present disclosure described above are represented as a series of operations for clarity of description, it is not intended to limit the order in which the steps are performed. The steps described above may be performed simultaneously or in different order as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative aspects of the present disclosure. Aspects or features described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A first server comprising:
memory configured to store at least one instruction; and
one or more processors configured to execute the at least one instruction stored in the memory to:
send, to a second server, attribute information of a mobility device, wherein the attribute information indicates that a service of at least one device part of the mobility device is associated with at least one of an accident risk value or a user convenience value of the mobility device;
receive, from the second server, a first assessment estimate that is determined based on at least one of the accident risk value or a user convenience value;
receive, from a user device, an indication of approval of the first assessment estimate; and
send, to the second server, information about the indication of approval of the first assessment estimate.

2. The first server of claim 1, wherein the one or more processors are further configured to:
receive, from the user device, a request for a second service of at least one second device part of the mobility device, wherein the second service is associated with at least one of a second accident risk value or a second user convenience value of the mobility device; and
receive, based on the request, a second assessment estimate that is determined based on at least one of the second accident risk value or the second convenience value.

3. The first server of claim 2, wherein the one or more processors are further configured to:
send, to the user device, the second assessment estimate;
receive, from the user device, an indication of approval of the second assessment estimate; and
send, to the second server, information about the indication of approval of the second assessment estimate.

4. The first server of claim 3,
wherein the second server comprises a plurality of second servers, and
wherein the one or more processors are further configured to receive, from the plurality of second servers, a plurality of assessment estimates, and wherein the second assessment estimate is different from at least one of the plurality of assessment estimates.

5. The first server of claim 1, wherein the one or more processors are further configured to:
receive, from the user device, an indication of termination of the service for the mobility device; and
receive, from the second server, a second assessment estimate that reflects the termination of the service.

6. The first server of claim 5, wherein the one or more processors are further configured to:
send, to the user device, the second assessment estimate;
receive, from the user device, an indication of approval of the second assessment estimate; and
send, to the second server, information about the indication of approval of the second assessment estimate.

7. The first server of claim 6,
wherein the second server comprises a plurality of second servers, and
wherein the one or more processors are further configured to receive, from the plurality of second servers, a plurality of assessment estimates, and wherein the second assessment estimate that reflects the termination of the service is different from at least one of the plurality of assessment estimates.

8. A second server comprising:
a transceiver configured to transmit and receive one or more signals; and
one or more processors configured to control the transceiver,
wherein the one or more processors are configured to:
receive, from a user device, a request for an assessment estimate;
receive, from a first server, attribute information of a mobility device, wherein the attribute information indicates that a service of at least one device part of the mobility device is associated with at least one of an accident risk value or a user convenience value of the mobility device;
determine, based on at least one of the accident risk value of the user convenience value, a first assessment estimate;
send, to the user device, the first assessment estimate;
receive, from the user device, an indication of approval of the first assessment estimate; and
send, to the first server, information about the indication of approval of the first assessment estimate.

9. The second server of claim 8, wherein the one or more processors are further configured to:
receive, from the first server, an indication of a second service of at least one second device part of the mobility device, wherein the second service is associated with at least one of a second accident risk value or a second user convenience value of the mobility device; and
send, to the user device, a second assessment estimate that is determined based on at least one of the second accident risk value or the second user convenience value.

10. The second server of claim 9, wherein the one or more processors are configured to:
receive, from the user device, an indication of approval of the second assessment estimate; and
send, to the first server, information about the indication of approval of the second assessment estimate.

11. The second server of claim 10,
wherein the second server further comprises a plurality of second servers, and
wherein the one or more processors are configured to determine, for each of the plurality of second servers, a different one of a plurality of assessment estimates, and wherein the second assessment estimate is different from at least one of the plurality of assessment estimates.

12. The second server of claim 8, wherein the one or more processors are further configured to:
receive, from the first server, an indication of termination of the service; and
send, to the user device, a second assessment estimate that reflects the termination of the service.

13. The second server of claim 12, wherein the one or more processors are configured to:
receive, from the user device, an indication of approval of the second assessment estimate.

14. The second server of claim 13,
wherein the second server comprises a plurality of second servers, and
wherein the one or more processors are configured to determine, for each of the plurality of second servers, a different one of a plurality of assessment estimates, and wherein the second assessment estimate that reflects the termination of the service is different from at least one of the plurality of assessment estimates.

15. A method comprising:
sending, by a first server to a second server, attribute information of a mobility device, wherein the attribute information indicates that a service of at least one device part of the mobility device is associated with at least one of an accident risk value or a user convenience value of the mobility device;
receiving, from the second server, a first assessment estimate that is determined based on at least one of the accident risk value or the user convenience value;
receiving, from a user device, an indication of approval of the first assessment estimate; and
sending, to the second server, information about the indication of approval of the first assessment estimate.

16. The method of claim 15, further comprising:
receiving, from the user device, a request for a second service of at least one second device part of the mobility device, wherein the second service is associated with at least one of a second accident risk value or a second user convenience value of the mobility device; and
receiving, based on the request, a second assessment estimate that is determined based on at least one of the second accident risk value or the second user convenience value.

17. The method of claim 16, further comprising:
sending, to the user device, the second assessment estimate;
receiving, from the user device, an indication of approval of the second assessment estimate; and
sending, to the second server, information about the indication of approval of the second assessment estimate.

18. The method of claim 17,
wherein the second server comprises a plurality of second servers, and
wherein the method further comprises:
receiving, from the plurality of second servers, a plurality of assessment estimates, and wherein the second assessment estimate is different from at least one of the plurality of assessment estimates.

19. The method of claim 15, further comprising:
receive, from the user device, an indication of termination of the service for the mobility device; and
receiving, from the second server, a second assessment estimate that reflects the termination of the service.

20. The method of claim 19, further comprising:
sending, to the user device, the second assessment estimate;
receiving, from the user device, an indication of approval of the second assessment estimate; and
sending, to the second server, information about the indication of approval of the second assessment estimate.
